(19) United States
(12) Patent Application Publication
(10) Pub. No.: US 2006/0180325 A1
(43) Pub. Date: Aug. 17, 2006

(54) Construction apparatus

(76) Inventor: Erwin Stoetzer, Aichach (DE)

Correspondence Address: JACOBSON HOLMAN PLLC, 400 SEVENTH STREET N.W., SUITE 600, WASHINGTON, DC, 20004, US

(21) Appl. No.: 11/263,995

(22) Filed: Nov. 2, 2005

(30) Foreign Application Priority Data
Nov. 8, 2004 (EP) 04 026 491.3

(51) Int. Cl. A01B 63/00

(52) U.S. Cl. 172/452

(57) ABSTRACT

The invention relates to a construction apparatus comprising a carriage and a mast element, with a hinge being provided on the mast element, about which the mast element can be pivoted on the carriage from an approximately vertical operating position into an inclined transport position, in which the mast element extends longitudinally beyond the carriage. In a construction apparatus according to the invention the hinge is arranged on a slide that is provided on the carriage by being guided in a longitudinally displaceable manner.

The invention relates to a construction apparatus comprising a carriage and a mast element, with a hinge being provided on the mast element, about which the mast element can be pivoted on the carriage from an approximately vertical operating position into an inclined transport position, in which the mast element extends longitudinally beyond the carriage.

A construction apparatus according to the preamble can be taken from DE 44 36 264 C1. The construction apparatus known from this printed publication has a two-part mast comprising an upper and a lower mast element. The upper mast element is hinged by means of an upper hinge to the lower mast element and the lower mast element is hinged by means of a lower hinge to a carriage. In the approximately vertical operating position of the mast the two mast elements are locked in an aligned working position. In order to transport the construction apparatus the two mast parts are pivoted about the hinges in such a manner that the lower mast element extends forwards in an upward-inclined manner, while the upper mast element is folded backwards into a horizontal position, in which it extends longitudinally beyond the carriage. According to DE 44 36 264 C1 the lower hinge can be provided on a tubular boom, whose outer surface forms a slide fit together with the inner surface of a sleeve-shaped receiving part provided on the carriage of the construction apparatus. As a result, a pivoting movement of the raised mast is ensured both in a longitudinal plane of the carriage and transversely thereto.

The object of the invention is to provide a construction apparatus that is particularly simple in its construction and compact during transport.

The object is solved in accordance with the invention by a construction apparatus having the features of claim 1. Preferred embodiments are stated in the dependent claims.

The construction apparatus according to the invention is characterized in that the hinge is arranged on a slide, which is provided on the carriage by being guided in a longitudinally displaceable manner.

A fundamental idea of the invention may be seen in the fact that the mast element, which extends beyond the carriage in the transport position, is hinged by means of the hinge directly to a slide that is guided in a longitudinally displaceable manner. For the transport of the construction apparatus this slide can be displaced forwards on the construction apparatus together with the hinge, whereby the distance of the hinge to the carriage centre is increased. This proves to be of particular advantage if obstructions that project upwards longitudinally to the inclined mast element, such as a cable winch, are arranged on the carriage, which limit the maximum pivoting angle of the mast element in the transport position. Through a forward displacement of the slide together with the hinge on the carriage the distance of the hinge to these obstructions can be increased and a larger maximum pivoting angle of the mast element can be achieved thereby in the transport position. As a result, the vertical clearance of the construction apparatus can be reduced in the transport position of the mast element and consequently a particularly compact construction apparatus can be obtained in a particularly simple manner.

Acording to the invention, since the mast element that extends longuitudinally beyond the carriage in the transport position is itself hinged to the slide, there is no need for a second mast element to be placed into an obliquely upward extending position in order to transport the construction apparatus. Hence, according to the invention the design of the construction apparatus is particularly simple.

In addition, through a forward displacement of the hinge according to the invention together with the mast element on the carriage, the tilt resistance of the construction apparatus can be increased in the transport position of the mast element, especially in the case of long mast elements and/or masts. For instance by displacing the hinge forwards, i.e. away from the carriage centre and/or from the centre of gravity of the carriage, the centre of gravity of the mast element and/or of the mast can be moved into the range of the centre of gravity of the carriage in the transport position, so that torques on the construction apparatus can be reduced.

When the mast element is located in its approximately vertical operating position, a retraction of the slide with the mast element can equally bring about a displacement of the gravity centre of the mast element and/or of the mast closer to the carriage centre, whereby the tilt resitance of the construction apparatus can be increased.

A particularly reliable operation of the construction apparatus in accordance with the invention is rendered possible in that for the active displacement of the slide an operating drive is provided thereon, in particular a linear drive that preferably extends in one displacement direction of the slide. Advantageously, the slide can be displaced linearly, i.e. it is supported on the carriage in a one-dimensionally displaceable manner, and here it is of advantage for the displacement direction to extend at least approximately horizontally. By preference, the linear drive is designed as a hydraulic operating cylinder. However, it can also be designed as a rack-and-pinion drive or a spindle drive for instance. It is suitable for the linear drive to be arranged, in particular hinged on its one side to the slide and on its other side to the carriage.

The stability of the construction apparatus according to the invention can be increased in that the slide is guided on the carriage in a rotationally fixed manner. In particular, this can be understood in that a turning of the slide with respect to the carriage is not possible about a longitudinal axis of the carriage.

The reliability of the construction apparatus according to the invention can be enhanced in that on the carriage a guide frame, in particular comprising at least two guide rails, is arranged for guiding the slide, with the said slide being guided in particular on and/or under the guide frame. The guide frame is suitably arranged on a ground-facing component group of the carriage, and preferably on a ground-facing component group of an upper carriage of the carriage.

Furthermore, it is advantageous for the hinge to be arranged on the mast element in a portion which is spaced from the base of the mast element. According to this embodiment the hinge is therefore not arranged directly on the mast base but is offset upwards along the mast element with respect to the base. As a consequence, the mast element projects from underneath the hinge, which is preferably arranged on the upper carriage of the carriage and, especially when the mast element is located in the operating position, it reaches comparatively close to the ground. This allows for a particularly reliable and versatile tool guidance along the mast element. Since the mast element extends on both sides of the hinge in this arrangement of the hinge according to the invention, the forces required to raise the mast element from the transport position into the operating position are particularly low. Advantageously, the hinge is arranged in the lower quadrant, in particular in the lower octant of the mast element.

In accordance with the invention the hinge serves to pivot the mast element between the transport position and the operating position. In addition, provision can also be made for the mast element to be pivoted about the hinge during the operation of the construction apparatus, for example to make holes in the soil that extend obliquely to the vertical line. The pivoting of the mast element about the hinge suitably takes place in a longitudinal plane of the construction apparatus and/or the carriage. A particularly versatile construction apparatus can be achieved in that a further hinge is provided, in particular between the hinge and the mast element, for the transverse pivoting of the mast element. Here a transverse pivoting can be understood in particular as a pivoting movement of the mast element in a transverse direction to the longitudinal plane. A particularly compact construction apparatus can be attained in that the further hinge is arranged directly on the mast element, and in particular it can be arranged on the mast element by being at least partly offset backwards with respect to a longitudinal side of the mast element facing towards the carriage.

In accordance with the invention the transport dimensions of the construction apparatus can be reduced in that a longitudinally extending recess is provided on the carriage in order to accommodate the mast element in its transport position. Hence, according to this embodiment the carriage can project upwards from both sides of the folded mast element at least in some portions thereof. In the transport position of the mast element an operator's cabin of the construction apparatus is suitably arranged laterally adjacent to the mast element and/or is located laterally adjacent to the guide frame.

A particularly efficient and at the same time compact construction apparatus can be achieved according to the invention in that on both sides of the recess at least one hydraulic power pack each is provided on the carriage for the supply of hydraulic drives of the construction apparatus. A hydraulic power pack is understood here as a device, by means of which a hydraulic fluid can be acted upon by pressure. The two power packs suitably serve to supply different hydraulic drives respectively. For example a first power pack may be provided for the supply of a drive employed for the drive operation of the carriage and for a turning movement of the upper carriage on a lower carriage. The second power pack can in turn serve to supply hydraulic drives for adjusting the inclination of the mast element, for moving the slide and/or for operating a drilling tool located on the mast element. In principle, provision can also be made for both power packs to supply one common hydraulic circuit.

To achieve a particularly simple pivoting movement of the mast element between its transport position and its operating position it is intended according to the invention that at least one hydraulic neck cylinder is provided, which is hinged on its one side to the carriage and on its other side to the mast element above the hinge. Advantageously, two neck cylinders are provided that extend parallel to each other in particular. For a particularly large pivoting angle of the mast element in the transport position the hydraulic neck cylinder is preferably arranged laterally on the mast element, i.e. on a longitudinal side of the mast element extending approximately parallel to the longitudinal plane.

A construction apparatus that is particularly easy to transport is characterized in that on the mast element at least one support is provided for retaining a drill rod. Such a drill rod that can be designed as a Kelly rod in particular can be guided on the mast element in a longitudinally displaceable manner during the operation of the construction apparatus. For the transport of the construction apparatus this guide can be detached and the drill rod can be placed into the support on the mast element. The support is suitably designed in the shape of a half-shell. Advantageously, in addition to being supported whilst located in the support, the drill rod is also supported by the at least one hydraulic neck cylinder during the transport of the construction apparatus. By preference, the drill rod is arranged above the mast element and extends at least approximately horizontally during the transport of the construction apparatus.

In the following the invention is described in greater detail by way of preferred embodiments schematically shown in the Figures, wherein:

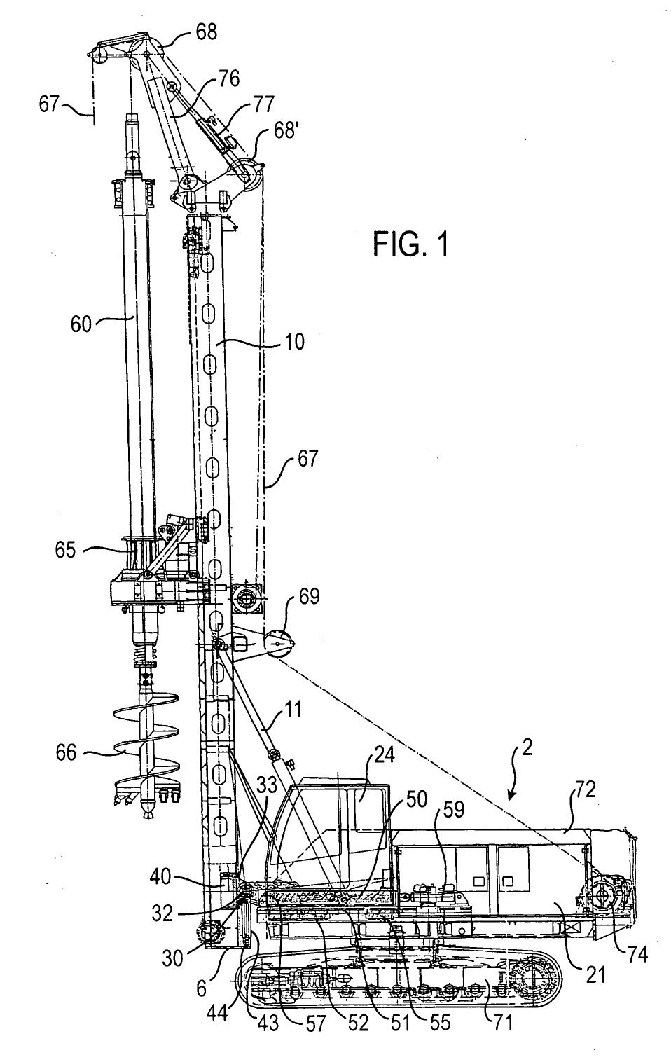

FIG. 1 shows a lateral view of the construction apparatus according to the invention, in which the mast element is located in an approximately vertical operating position;

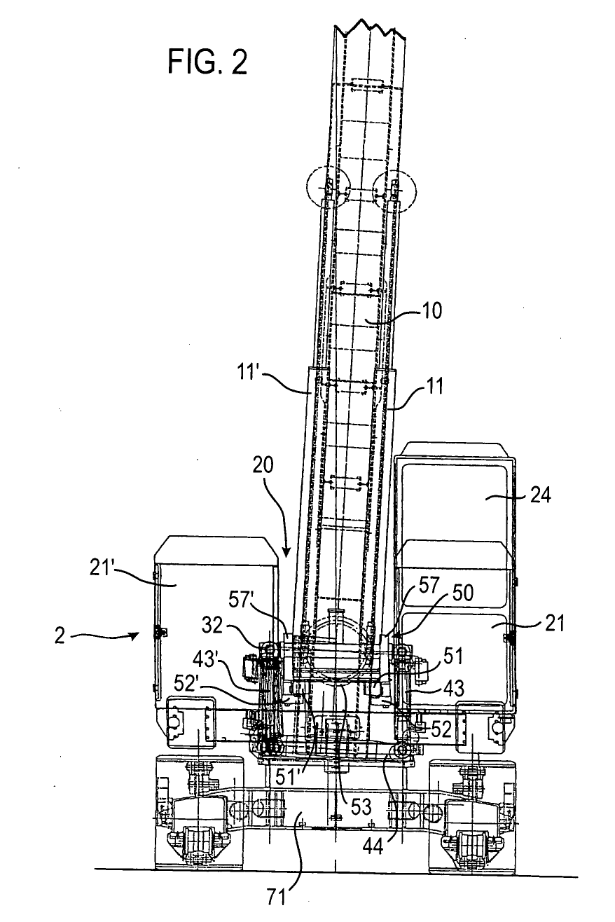

FIG. 2 shows a front view of the construction apparatus of FIG. 1 without drilling tool, drilling rod or power rotary head and with the mast element located in the operating position, and here, for the purpose of drilling in an inclined manner, the mast element is pivoted transversely to a longitudinal plane and is illustrated in broken lines in its upper portion; and

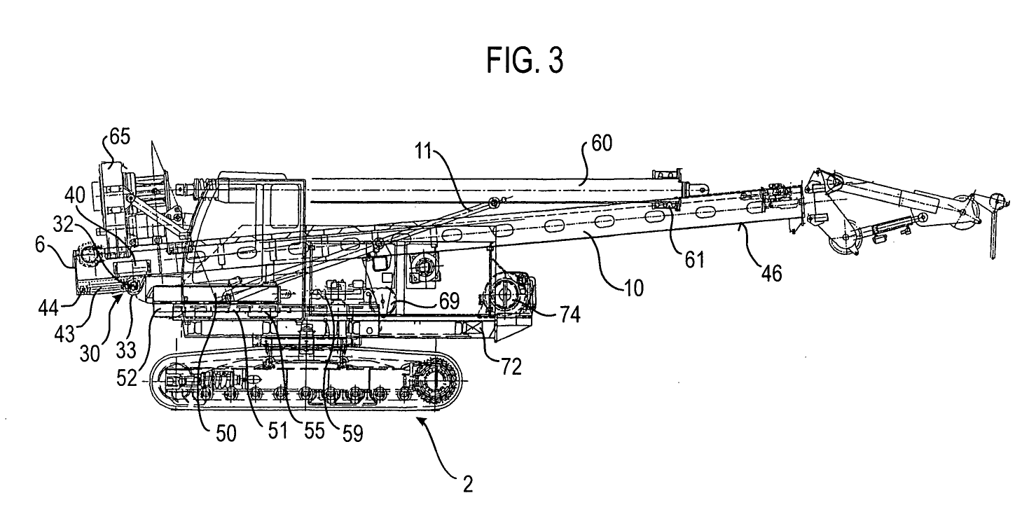

FIG. 3 shows a lateral view of the construction apparatus of FIG. 1 in its transport condition, in which the mast element is pivoted into its transport position.

A construction apparatus according to the invention is illustrated in FIGS. 1 to 3. The construction apparatus has a carriage 2 comprising a lower carriage 71 designed as a crawler running gear and an upper carriage 72 rotatably supported on the latter. A pivotable mast element 10 is hinged to the upper carriage 72 of the carriage 2 in the longitudinal plane thereof. In the illustrations of FIGS. 1 and 2 the mast element 10 is located in an operating position, in which the mast element 10 extends approximately in the vertical direction. In the illustration of FIG. 3, however, the mast element 10 is shown in a transport position, in which the mast element 10 is pivoted in the longitudinal plane of the upper carriage 72 such that it extends backwards beyond the carriage 2.

In order to pivot the mast element 10 longitudinally, i.e. to pivot the mast element 10 in the longitudinal plane of the upper carriage 72, a hinge 30 is provided on the ground-facing side of the mast element 10. This hinge 30 has a hinge axis 32 that extends horizontally and transversely to the longitudinal plane and two hinge bearing plates 33 that protrude longitudinally from the mast element 10 and through which the hinge axis extends. The hinge bearing plates 33 are arranged above the base 6 of the mast element 10.

The hinge axis 32 of the hinge 30 is arranged on a slide 50 guided in a longitudinally displaceable manner on the upper carriage 72. To this end, provided on the upper carriage 72 are two guide rails 51, 51′ extending parallel and longitudinally to the upper carriage 72, which are embraced laterally and from below, i.e. from the ground-facing side, by a respective front guide skid 52, 52′ of the slide 50 that has an L-shaped cross-sectional profile. Above the two front guide skids 52, 52′ the slide 50 has a transversely extending yoke 53, which connects the two front guide skids 52, 52′. This yoke 53 rests on the upper side of the guide rails 51, 51′. In addition to the two front guide skids 52, 52′ and spaced therefrom the slide 50 has two rear guide skids 55 that are equally designed with an L-shaped cross-sectional profile and embrace the guide rails 51, 51′. The terms “front” and “rear” can be understood here in relation to the hinge 30, i.e. the front guide skids 52, 52′ are arranged closer to the hinge 30 than the rear guide skids 55. The rear guide skids 55 are likewise connected to each other by a transversely extending yoke. As a result of the guide skids 52, 52′, 55 and the yokes connecting these skids, the slide 50 is guided on the carriage 2 in a rotationally fixed manner whilst being displaceable solely in the longitudinal direction and parallel to the guide rails 51, 51′.

At the front of the slide 50 two vertically extending retaining plates 57 are provided, through which the hinge axis 32 extends in particular in a rotational manner. For the active displacement of the slide 50 a hydraulic operating cylinder 59 is arranged on the rear of the said slide, which is in turn arranged on the upper carriage 72. In FIG. 3 the piston rod of the operating cylinder 59 is depicted as being detached from the slide 50.

Through the slide 50 it is possible to horizontally displace the hinge 30 and consequently the lower portion of the mast element 10 with respect to the upper carriage 72 of the carriage 2. In particular, as depicted in FIG. 3, the slide 50 can be displaced forwards on the upper carriage 72 together with the hinge 30 in order to transport the construction apparatus. As a result, it is possible to increase the maximum pivoting angle of the mast element 10, i.e. the maximum angle of the mast element 10 with respect to the vertical line. This maximum pivoting angle can in particular be defined by an obstruction located at the rear of the upper carriage 72, such as a cable winch 74, which limits the pivotal motion path of the mast element 10. Through a forward displacement of the hinge 30 by means of the slide 50 the distance of the hinge 30 to this obstruction is enlarged and the maximum possible pivoting angle is thereby increased.

However, as can be taken from FIG. 1, the slide 50 is retracted during the operation of the construction apparatus and the centre of gravity of the mast element 10 is thereby displaced closer to the centre of gravity of the carriage 2 so as to increase the tilt resistance.

As shown in FIG. 1, the construction apparatus according to the invention can be employed for the operation of a soil working implement 66 designed as an auger in the illustrated embodiment. This soil working implement 66 is arranged at the ground-facing side on a telescopic drill rod 60, which is longitudinally guided and rotatably drivable on the mast element 10 by means of a power rotary head 65. In operation the drill rod 60 is suspended on its upper side on a cable 67 that is guided via two guide pulleys 68, 68′ arranged on the head of the mast element 10 and a guide pulley 69 arranged longitudinally on the mast element 10 to the cable winch 74 located at the rear of the upper carriage 72. While the rear guide pulley 68′ of the two guide pulleys located on the mast head is supported in a stationary manner on the head of the mast element 10, the front guide pulley 68 is pivotally supported on the mast element 10 by means of a boom 76. For the active pivoting of the boom 76 with the front guide pulley 68 a linear drive 77 is provided.

In the operating condition depicted in FIG. 1 the front guide pulley 68 is pivoted forwards into an aligned position with the drill rod 60. In contrast to this, in the transport condition depicted in FIG. 3 it is pivoted backwards through a retraction of the linear drive 77, as a result of which the vertical clearance of the construction apparatus is reduced.

As can also be taken from FIG. 3, in order to achieve a further reduction of the vertical clearance of the construction apparatus in its transport position the drill rod 60 can be removed from the longitudinally guiding power rotary head 65, detached from the cable 67 and can be placed on a support 61 provided in the upper portion of the mast element 10.

As can be gathered from FIG. 2 in particular, the upper carriage 72 has in its centre a recess 20 which extends longitudinally to the upper carriage 72 and into which the mast element 10 is placed in its transport position. On both sides of this recess 20 a hydraulic power pack 21, 21′ is each provided for the generation of hydraulic pressure. In front of the power pack 21 on the left side and laterally adjacent to the power pack 21′ on the right side an operator's cabin 24 is additionally provided on the upper carriage 72.

For the active longitudinal pivoting of the mast element 10, in particular between its operating position and its transport position, two parallel extending neck cylinders 11, 11′ are provided, which are each hinged on their one side to the mast element 10 and on their other side to the slide 50. Alternatively, the neck cylinders 11, 11′ can also be hinged to a stationary part of the upper carriage 72. However, since the neck cylinders 11, 11′ are hinged to the slide 50, the longitudinal pivoting of the mast element 10 is independent of the position of the slide 50 on the upper carriage 72.

As can be taken more particularly from FIG. 2, in addition to being supported in a longitudinally pivotable manner by means of the hinge 30, the mast element 10 is also provided in a transversely pivotable manner on the upper carriage 72. In this context the transverse pivoting movement is understood as a pivoting movement transversely to the longitudinal plane of the upper carriage 72. For the transversely pivotable support of the mast element 10 on the upper carriage 72 a further hinge 40 is provided on the hinge bearing plates 33 of the hinge 30, the rotational axis of which is arranged perpendicularly to the rotational axis of the hinge 30. This hinge 40 is constituted by a bolt formed on the hinge bearing plates 33 which engages into a sleeve located on the mast element 10. Alternatively, the sleeve can also be formed on the hinge bearing plates 33 and the bolt can be formed on the mast element 10. Just as the hinge 30 the hinge 40 located directly adjacent thereto is spaced from the base 6 of the mast element 10. For a particularly compact construction the hinge 40 is arranged in a rear-offset manner towards the inside of the mast element 10 with respect to the longitudinal side 46 of the mast element 10 facing towards the carriage.

As can also be gathered from FIG. 2 in particular, for the active transverse pivoting of the mast element 10 about the hinge 40 a pivotal linear drive designed as a hydraulic pivot cylinder 43, 43′ is respectively provided on both sides of the mast element 10. In FIG. 2 the pivot cylinder 43 is shown in different pivoting conditions. The two pivot cylinders 43, 43′ are each arranged, more particularly hinged on their one side to the hinge axis 32 of the hinge 30 and on their other side to a yoke 44 located on the base of the mast element 10 and extending transversely thereto. The rotational axes of these hinges extend at least approximately parallel to the rotational axis of the hinge 40. By operating the two pivot cylinders 43, 43′ in opposite directions the yoke 44 and consequently the mast element 10 connected therewith is pivoted transversely with respect to the hinge bearing plates 33 and consequently the upper carriage 72.

Just as the two pivot cylinders 43, 43′ the two neck cylinders 11, 11′ are also arranged parallel to each other, as a result of which two hinge points of the neck cylinders 11, 11′ are present on the mast element 10. In order to promote the active transverse pivoting of the mast element 10 the two neck cylinders 11, 11′ are likewise displaced in opposite directions in synchronization with the counter-directed operation of the two pivot cylinders 43, 43′.

1. Construction apparatus comprising
a carriage and
a mast element, with
a hinge being provided on the mast element, about which the mast element can be pivoted on the carriage from an approximately vertical operating position into an inclined transport position, in which the mast element extends longitudinally beyond the carriage,
wherein
the hinge is arranged on a slide that is provided on the carriage by being guided in a longitudinally displaceable manner.

2. Construction apparatus according to claim 1,
wherein
for the active displacement of the slide an operating drive is provided thereon, in particular a linear drive that preferably extends in one displacement direction of the slide.

3. Construction apparatus according to claim 1,
wherein
the slide is guided on the carriage in a rotationally fixed manner.

4. Construction apparatus according to claim 1,
wherein
on the carriage a guide frame, comprising at least two guide rails in particular, is arranged for guiding the slide, with the said slide being guided in particular on and/or under the guide frame.

5. Construction apparatus according to claim 1,
wherein
the hinge is arranged on the mast element in a portion which is spaced from the base of the mast element.

6. Construction apparatus according to claim 1,
wherein
between the hinge and the mast element a further hinge is arranged for the transverse pivoting of the mast element.

7. Construction apparatus according to claim 1,
wherein
on the carriage a longitudinally extending recess is provided for accommodating the mast element in its transport position.

8. Construction apparatus according to claim 7,
wherein
on the carriage at least one hydraulic power pack is provided for the supply of hydraulic drives of the construction apparatus.

9. Construction apparatus according to claim 1,
wherein
at least one hydraulic neck cylinder is provided, which is hinged on its one side to the carriage and on its other side to the mast element above the hinge.

10. Construction apparatus according to claim 1,
wherein
on the mast element at least one support is provided for retaining a drill rod.
